(19) United States
(12) Patent Application Publication
(10) Pub. No.: US 2016/0062323 A1
(43) Pub. Date: Mar. 3, 2016

(54) Physical Layer Diagnostics in a Fieldbus Device

(71) Applicant: Relcom, Inc., Forest Grove, OR (US)

(72) Inventor: Michael Alan Strauser, Gaston, OR (US)

(73) Assignee: Relcom, Inc., Forest Grove, OR (US)

(21) Appl. No.: 14/471,228

(22) Filed: Aug. 28, 2014

(51) Int. Cl. G05B 9/02

(52) U.S. Cl. CPC G05B 9/02

(57) ABSTRACT

A fieldbus device within a fieldbus network segment comprises a functional layer and includes an integral physical layer diagnostic (PhLD) element for measuring an electrical parameter of the fieldbus network segment. Placing the PhLD element within the fieldbus device itself provides for greater accuracy in monitoring electrical characteristics of the segment.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

The present invention relates to a fieldbus network and, more particularly, to improving the acquisition of information about the health of the physical network that includes fieldbus devices.

In a typical industrial plant application, sensors measure position, motion, pressure, temperature, flow, and other parameters related to the operation of process machinery and activities. Actuators, such as valves and motor controllers, control the operation of the machinery and process activities. The sensors and actuators are remotely located from the human and computerized controllers which gather information from the sensors and direct the operation of the actuators. A communication network links the controllers with the sensors and actuators located in the field, normally an industrial plant environment.

Heretofore, communication between the controllers, remote sensors, and actuators in industrial applications has been by means of analog signaling. The prevailing standard for analog networking of field devices with the control room in industrial applications has been the Instrument Society of America standard, ISA S50.1. This ISA standard provides for a two-wire connection between the controller and each field device. The wire pair carries the analog signal between the remote device and the controller. Since many devices are now controlled by microprocessors, the analog signal may be converted to a digital signal useful to a computerized controller. The wire pair also supplies DC power for operation of the remote sensor or actuator.

Alternatively, communication utilizing digital signaling can be used to reduce the susceptibility of the analog communication system to errors, and provides a capability for conveying a wide range of information over the communication network. Digital communication also permits several different devices to communicate over a single pair of wires.

“Fieldbus” is a generic term used to describe a digital, bidirectional, multi-drop, serial communication network for connecting field devices, such as controllers, actuators, and sensors, in industrial applications. One such fieldbus is defined by IEC as standard 61158-2. This system utilizes a two-wire bus to provide simultaneous digital communication between the remotely located devices and DC power distribution to these devices.

Traditional Physical Layer Diagnostics (PhLD) in fieldbus systems are conventionally done with dedicated devices either in the control room or at a field junction box. This diagnostic information is needed so that power and signal distribution over the network is up to standards required for reliable operation of the control system. In the past PhLD devices were hand-held devices, temporarily connected to a fieldbus segment in order to check or document its performance, or to troubleshoot an issue. They were not permanently connected to a segment to monitor it continuously. More recently, PhLD devices have been semi-permanently connected to the segment and various methods have been used to transmit the data to the control system. These have included RS485, Ethernet, and the fieldbus segment itself.

There are PhLD devices that incorporate a fieldbus interface, which is how they communicate with the host (and end user). Such devices are coupled to a fieldbus segment, but are independent of any particular fieldbus device. FIG. 1 illustrates a typical fieldbus segment, which is a branch of a larger fieldbus network. Elements labeled “X” are devices that contain a fieldbus interface. They can communicate on the fieldbus between each other and the Host. Those labeled “D” are currently available fieldbus diagnostics devices that include a fieldbus interface. Diagnostics is the sole function of the two “D” devices, but usually only one is on a segment. As the drawing shows, a diagnostics device “D” could also be in the control room or in the field. The four “X” devices connected to the fieldbus device coupler are ‘real’ fieldbus devices in that they perform an active function for the end user (i.e., measure pressure of the process or control a valve in the process plant). A drawback to this arrangement is that the PhLD devices can be isolated from the fieldbus devices downstream of the device coupler, and so are unable to accurately monitor electrical parameters on the spur lines coupling to the fieldbus devices.

The foregoing and other objectives, features, and advantages of the invention will be more readily understood upon consideration of the following detailed description of the invention taken in conjunction with the accompanying drawings.

### BRIEF DESCRIPTION OF THE SEVERAL DRAWINGS

FIG. 1 is a block schematic diagram of a typical prior art fieldbus segment that includes physical layer diagnostic (PhLD) devices separate from fieldbus devices.

FIG. 2 is a block schematic diagram of a typical fieldbus segment.

FIG. 3 is a block schematic diagram of a fieldbus segment incorporating a preferred embodiment.

FIG. 4 is a block schematic diagram of a fieldbus device incorporating a preferred embodiment of an integral PhLD circuit.

FIG. 5 is a block schematic diagram of a fieldbus device incorporating a PhLD element for measuring DC voltage.

FIG. 6 is a circuit diagram of an exemplary fieldbus device incorporating a PhLD element for measuring DC current.

FIG. 7 is a circuit diagram of an exemplary fieldbus device incorporating a PhLD element for measuring signal level

FIG. 8a is a circuit diagram of an exemplary fieldbus device incorporating a PhLD element for measuring noise using an external noise filter.

FIG. 8b is a circuit diagram of an exemplary fieldbus device incorporating a PhLD element for measuring noise using a digital filter.

FIG. 9 is a waveform illustrating jitter.

FIG. 10a is a circuit diagram of an exemplary fieldbus device incorporating a PhLD element for measuring jitter.

FIG. 10b circuit diagram of an exemplary fieldbus device incorporating an alternative PhLD element for measuring jitter.

FIG. 11a circuit diagram of an exemplary fieldbus device incorporating a PhLD element for obtaining an oscilloscope trace.

FIG. 11b circuit diagram of an exemplary fieldbus device incorporating an alternative PhLD element for obtaining an oscilloscope trace.

FIG. 12 is a block diagram illustrating the architecture of a microcontroller in a fieldbus device employing a PhLD element.

FIG. 13 is a flow chart diagram of a computer program resident in a fieldbus device in communication with a host.

### DETAILED DESCRIPTION OF SEVERAL EMBODIMENTS

One of the benefits of a digital fieldbus system is its ability to communicate multiple items of information from each fieldbus device to the control system. This has included the health of the measuring system that is part of the fieldbus device, but to date, such devices have not included Physical Layer Diagnostics (PhLD) elements. Integrating PhLD elements into a fieldbus device simplifies and reduces the cost of a fieldbus installation. In addition, device couplers, which have isolation built into them, prevent the obtaining of diagnostic information about the fieldbus devices connected to them due to that isolation. Many conditions existing in the physical layer of fieldbus devices are analog phenomena. However, certain types of device couplers, which are necessary for fieldbus devices having microprocessor or digital control, block analog signals in order to perform their necessary conversion function. In addition, even device couplers that do not isolate the fieldbus device can have an effect on electrical characteristics of the fieldbus segment. Thus most data relating to certain parameters of fieldbus devices and electrical characteristics of the segment, which includes the fieldbus device, cannot be monitored by PhLD devices connected to a segment either in the plant or in the control room. With PhLD elements built directly into the fieldbus device, however, the functional layer conditions under which the fieldbus device is operating will be capable of being monitored.

While fieldbus installations are as varied as the industrial applications with which they are used, an exemplary fieldbus installation is illustrated in FIG. 2. A host 10 in the control room 11 is connected to one or more devices 12a, 12b in the field or plant environment 13 with a twisted pair trunk cable 14 operating on a fieldbus standard. Several devices can be connected to the trunk by spur cables 16a, 16b at a device coupler 18. Power to the devices is provided over the wiring by a fieldbus power supply 20. The fieldbus power supply gets its power from an ordinary DC power supply 22.

A fieldbus power supply is necessary to galvanically isolate the fieldbus wiring from the ordinary DC power supply and to provide a low frequency power path to the trunk 14 while blocking the signals on the wiring. If an ordinary DC power supply were used to power the wiring, it would attempt to maintain a constant voltage which would prevent propagation of the digital signal on the wiring. To simplify wiring diagrams, the positive and negative wire pairs can be shown as a single line. The combination of all of these objects connected together (except the DC power supply) is called a fieldbus segment. A fieldbus segment may comprise any number of fieldbus devices.

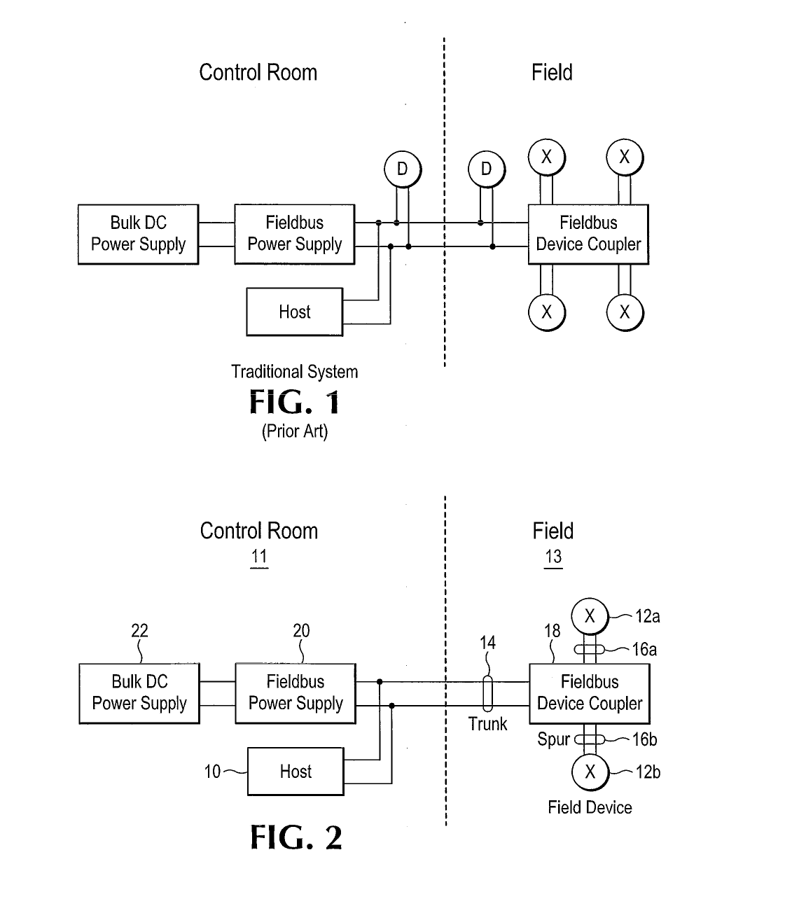

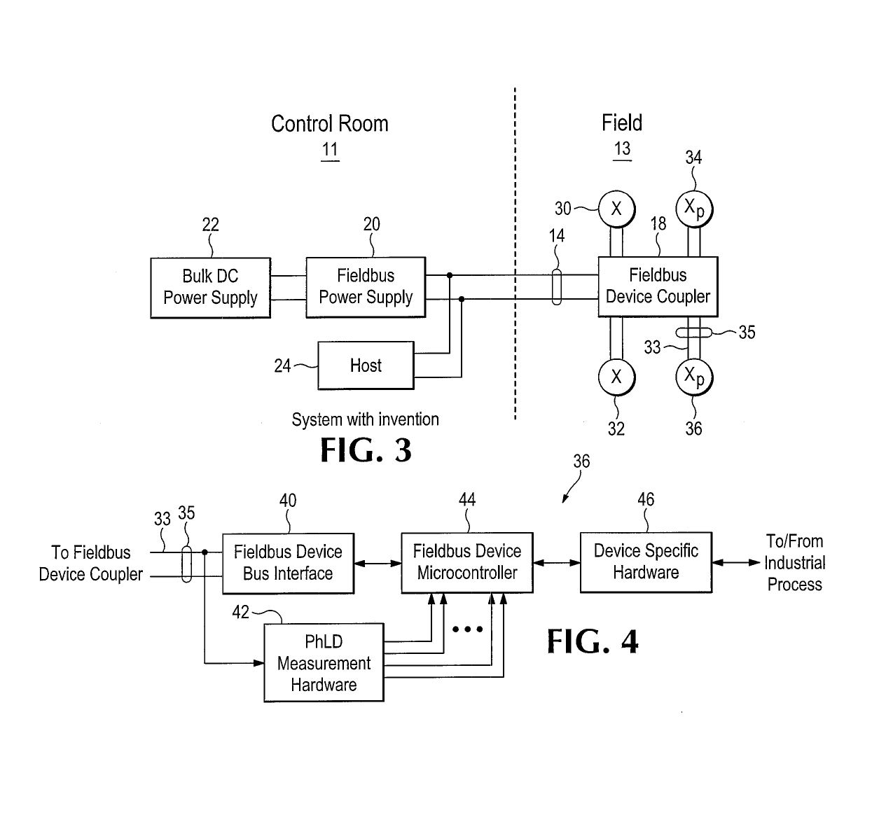

In FIG. 3 a fieldbus segment that is similar to that shown in FIG. 1, incorporates PhLD capability directly within certain fieldbus devices. The bulk DC power supply 22 is coupled to the fieldbus power supply 20 that feeds power to the trunk cable 14. A host 24, which may be a central controller such as a computer, is connected to the trunk cable 14. In the plant environment 13, represented by the other side of the dashed line, the trunk cable 14 connects to the fieldbus device coupler 18. The fieldbus device coupler 18 connects to fieldbus devices 30, 32, 34 and 36. Some of these devices such as devices 34 and 36, labeled Xp, have PhLD circuits incorporated within them, while fieldbus devices 30, 32, labeled X, do not. Thus fieldbus device 36, for example, which includes a PhLD circuit, is capable of monitoring selected electrical parameters present on the spur cable 35. This is not possible with the network of FIG. 1 because the PhLD elements in the network are isolated from the downstream fieldbus devices by the fieldbus device coupler.

Examples of the kinds of diagnostic information that can be measured in the fieldbus device with the PhLD elements are: DC Voltage, DC Current, Digital Signal level, Jitter (timing error of the digital signal), Noise, CRC errors, and Partial packets. This list is not intended to be exhaustive and other types of diagnostic information may be measured. The received information can also be used to calculate other characteristics of the network such as CRC errors, incomplete packets, retransmissions, fieldbus add/drop status, and number of active fieldbus devices. Other diagnostic information may include a time stamp which indicates when an event has occurred, fieldbus device address, fieldbus device tag, statistical monitoring, and the link active scheduler's address.

FIG. 4 illustrates one embodiment of a fieldbus Device 36 incorporating PhLD measurement hardware 42. The fieldbus device bus interface 40 has the necessary circuitry to condition the digital signal for the fieldbus device microcontroller 44 which does most or all of the processing within the fieldbus device 36. The device specific hardware 46 conditions the signals received from the industrial process (temperature, pressure, flow, etc.) to something that the microcontroller 44 can read. The microcontroller controls a functional layer such as device specific hardware 46 which may be, for example, a temperature sensor, pressure sensor or actuator.

In one embodiment, the PhLD element 42 is connected to the fieldbus segment in parallel with the device bus interface 40 and is coupled as an input to a microcontroller 44 in the fieldbus device 36. There may be multiple PhLD measurement circuits as part of the PhLD hardware as indicated by the multiple output lines of element 42, and these may be selectively activated by the host 10 or turned off as the host user desires. Any circuit component may be turned on or off by connecting a switching transistor between it and ground, under control of the microcontroller. The term “ground” as used herein when referring to the wire pair in a fieldbus segment is ground reference, not necessarily earth ground. This is because the wire pair such as trunk cable 14 consists of positive and negative wires that are, in most cases, isolated from earth ground.

The PhLD measurement hardware 42 is coupled to the positive line 33 of the trunk cable spur 35. Thus, it is connected to the fieldbus microcontroller 44 in parallel with the fieldbus device interface 40. This enables the PhLD element 42 to measure analog parameters on the segment coupling to the fieldbus device 36 without signal conditioning by the interface 40.

Some fieldbus devices are designed to control the industrial process in which case the device specific hardware 46 takes the microcontroller outputs and conditions them to control the process—usually, a valve or actuator. The device specific hardware 46 (sometimes called a functional layer herein), may include an additional microcontroller but this depends upon the application. Some of the bus interface circuitry and PhLD circuitry may be physically included within the fieldbus device microcontroller 44, which will also include the necessary software to present the PhLD's measurements to the control system (host user) via the fieldbus segment, i.e., through the device coupler 18 and the trunk line 14.

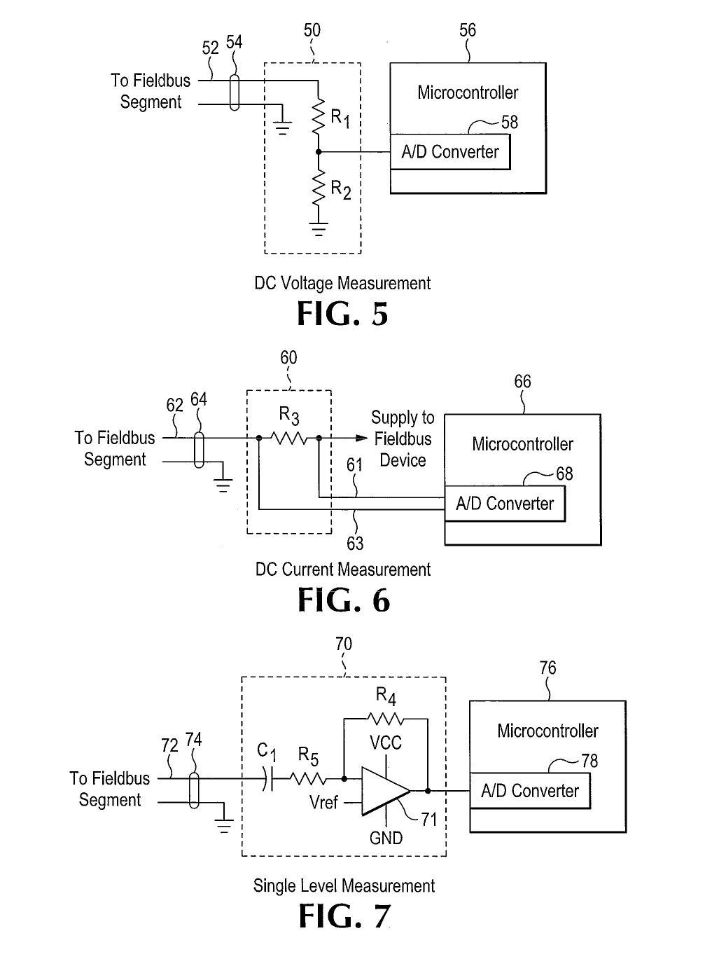

Several examples of PhLD measurement circuits or components are shown in FIGS. 5-11a and 11b. These circuits measure selected electrical parameters associated with fieldbus devices such as the electrical characteristics of the fieldbus network segment in which they are located. In FIG. 5, a PhLD measurement circuit 50 is coupled to the positive line 52 of a spur cable twisted pair 54. The circuit 50 comprises a voltage divider made up of resistors R1 and R2. A microcontroller 56 in a fieldbus device includes an analog to digital converter 58 which has, as an input, PhLD component 50. The microcontroller will periodically read the value of the voltage divider which will be a DC voltage across the spur cable 54.

In FIG. 6, a PhLD measurement device 60 is a circuit for measuring DC current. A resistor R3 is connected in series with the positive line 62 of spur trunk cable 64. Leads 61 and 63 across resistor R3 are connected to an input of an A/D converter 68 in a microcontroller 66 which controls a fieldbus device. Knowing the voltage across the resistor R3, the current may be calculated.

Signal level measurement is accomplished by the PhLD element 70 in FIG. 7. A network comprising coupling capacitor C1, amplifier 71, input resistor R5 and shunt resistor R4 is connected to an input of an A/D converter 78 in microcontroller 76. The PhLD device 70 is coupled through capacitor C1 to positive line 72 of spur line 74. The sensed signal is amplified and referenced to a known voltage, Vref, which is typically one-half of the A/D range. The A/D converter 78 is triggered twice to make measurements at the peak and valley of the waveform. The difference between these measurements is the signal level.

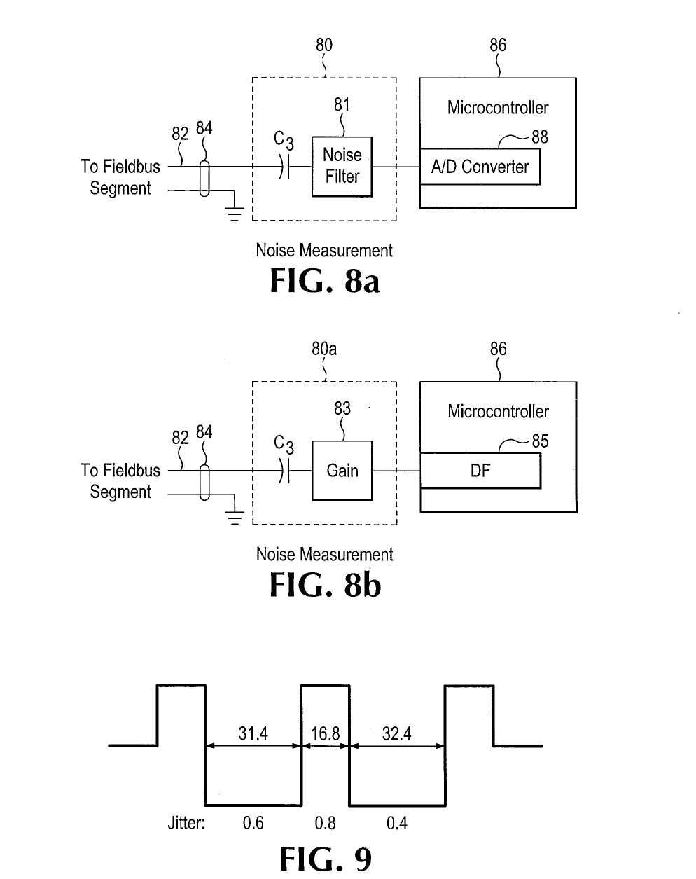

In FIG. 8a, a PhLD element 80 is a noise measurement circuit comprising filter 81 coupled to the positive line 82 of spur trunk cable 84 through capacitor C3. The filter 81 is connected to an input of an A/D converter 88 in a microcontroller 86. In a variation of this circuit, a gain circuit 83 comprises a PhLD noise measurement element 80a in which the gain circuit 83 couples to a digital filter 85 in the microcontroller 86. Software resident in the microcontroller 86 samples the noise signal over a time interval and picks the peak value as the current noise level. This sampling takes place during the silence period between data transmissions on the fieldbus segment.

Jitter is a measure of how far off the zero crossings are in a Fieldbus signal from their ideal locations. In a fieldbus signal, the zero crossing should occur either 16 or 32 microseconds from the last zero crossing. In the waveform of FIG. 9, the maximum jitter is 0.8 microseconds. Jitter may be measured for all transitions in the packet, but is typically done in the start or end delimiter as the jitter is always worse in these sections. Jitter can sometimes be associated with a particular fieldbus device and an average or maximum may be calculated for the fieldbus segment.

Because of the high resolution needed to measure jitter (better than 100 nanoseconds) a hardware implementation (as opposed to software) is normally required. This may be using dedicated hardware or a timer mechanism that is part of the microcontroller. Some software will be needed as well. For example, the hardware may make timing measurements between zero crossings, but the software will have to determine the jitter amount (subtract from 16 or 32 whichever is appropriate).

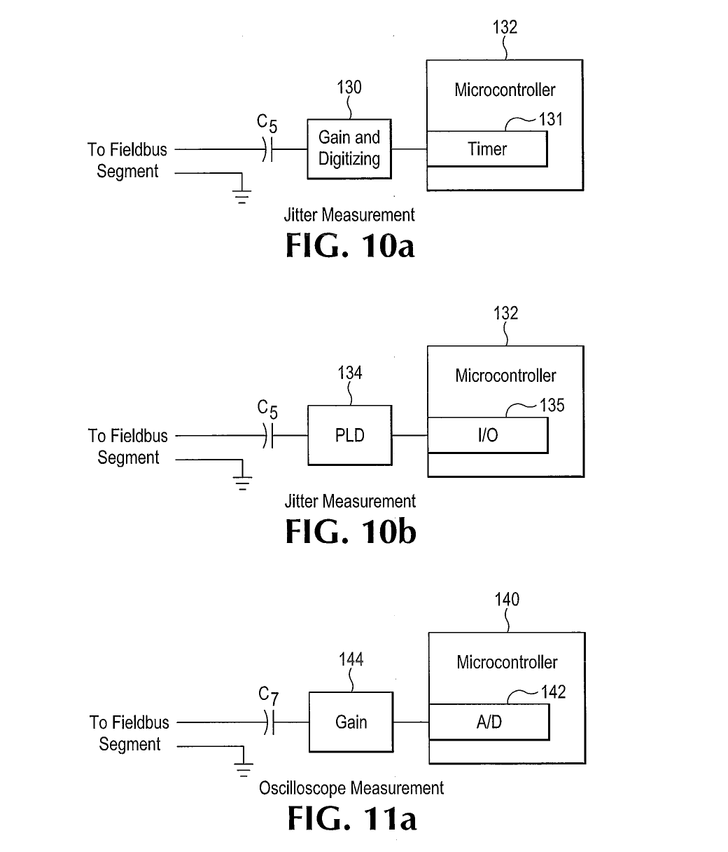

Two possible ways to implement jitter measurement with a PhLD are shown in FIGS. 10a and 10b. The example of FIG. 10a uses an internal timer 131 in the microcontroller 132 to make the measurements of the zero crossing timings. Gain and digitizing circuit 130 is coupled to the timer 131 via capacitor C5. The example of FIG. 10b uses dedicated hardware, such as a PLD (programmable logic device) 134, in this case the PLD 134 provides gain, digitizes the signal and measures the timing between zero crossings. It makes these measurements and then sends them to the microcontroller 132 on I/O input 135. In both examples, amplification, signal conditioning, and digitizing of the analog signal (for example, with a comparator) is required before the time measurements. Software in the microcontroller 132 must then calculate the jitter amount from the timing measurements.

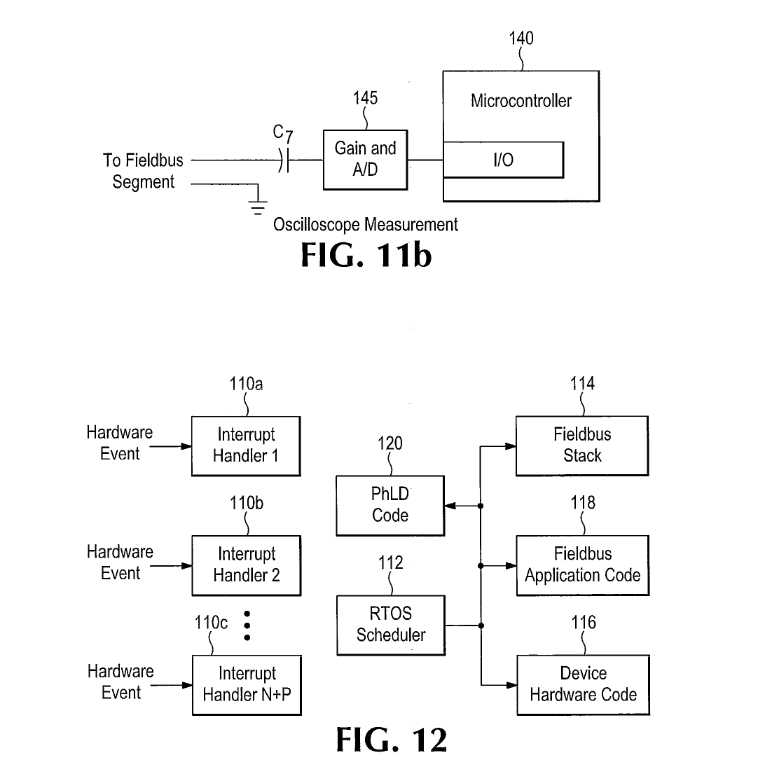

An oscilloscope measurement is a high-speed continuous capture of the shape of the fieldbus signal. When plotted on a computer screen it gives a view of voltage (vertical scale) verses time (horizontal scale). It can be used to determine the quality of the signal and whether there is noise of one kind or another. Due to the high speed required from the analog to digital converter (A/D), it may or may not be included inside the microcontroller. The example of FIG. 11a shows an A/D 142 being used inside the microcontroller 140. The input signal is coupled to the A/D 142 converter in the microcontroller 140 by capacitor C7 and a gain circuit 144. The example of FIG. 11b uses an external A/D and gain circuit 145 which then transmits results to the microcontroller 140 digitally (usually high speed serial such as SPI or I2C). In both examples, some gain or preconditioning of the signal from the fieldbus segment is required (circuits not shown).

Software within the microcontroller receives requests for a scope capture of some type. This may be a particular fieldbus device (using its address) or maybe an event (jitter exceeding a user specified threshold). The software then causes the microcontroller to capture the requested scope data and sends it to the Host (using the fieldbus stack).

In several of the illustrations above, the microcontroller coupled to the PhLD measurement component samples the input from the PhLD element during the time between data transmissions. In the case of jitter, signal level, and scope measurements, the data is gathered during a transmission. Thus, the diagnostic and operational functions are time shared in each fieldbus device. This information may be stored in memory and then made available to the control system over the trunk line 14 in response to inquiry from the host 10. The host 10 can enable or disable selected measurements as desired by transmitting instructions to each fieldbus device's microcontroller. If desired, a fieldbus device could have alarm limits programmed within it so that if the PhLD element measured a characteristic that exceeded an alarm limit, an alarm would be raised. These alarm limits could be altered by the host software if desired by the user, so that fieldbus devices could be adjusted for differing conditions inside the plant environment. In addition, alarms normally enabled could be disabled if desired.

FIG. 12 shows the architecture of the software/firmware resident in a typical fieldbus microcontroller such as fieldbus microcontroller 44. The PhLD hardware 42 reads hardware events. As shown in FIG. 4 there may be multiple circuits attached to the fieldbus device microcontroller.

Code embedded in the fieldbus microcontroller includes interrupt handlers 110a, b and c. These routines briefly interrupt the processor so that it reads PhLD data and then return control back to the interrupted routine. When more PhLD hardware is added, the number of interrupt handlers will likely increase. An RTOS scheduler 112 (Real Time Operating System) is typically used to assure that all routines within the processor are executed in a timely manner—that no one routine preempts any other for too long. RTOS's are commonly used in many embedded applications such as a fieldbus device. A typical fieldbus microcontroller has three main code functions that are given time to execute by the RTOS. The fieldbus Stack 114 is the code that controls communication over the fieldbus segment—it is a protocol stack specifically designed for fieldbus. The device hardware code 116 is the interface to the hardware that is performing the function of the fieldbus device (pressure measurement, temperature measurement, valve positioning, etc.). The fieldbus application code 118 interfaces between the fieldbus Stack 114 and the device hardware code 116 to present the acquired data in a standard format already defined by the fieldbus standard. This also includes the ability to generate alarms when something is out of a user-defined range as determined by the host. A fieldbus device with PhLD elements adds code to process the PhLD measurements (PhLD code 120) and put the data in a form that can be sent to the host using the standard fieldbus messaging protocol which is built into the fieldbus stack. This requires added fieldbus application code 118.

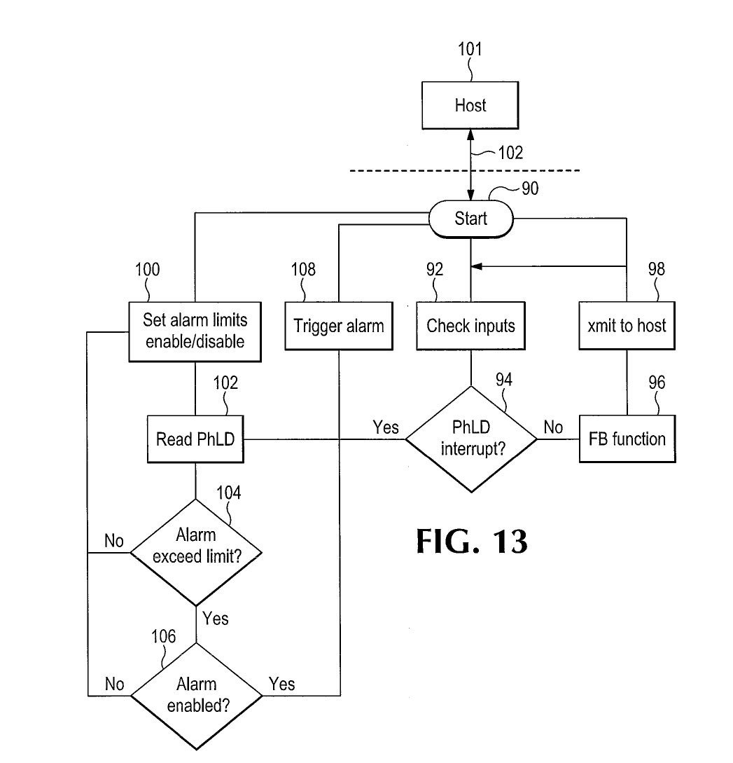

The operation of a typical microcontroller resident in a fieldbus device is shown in FIG. 13. All of the functional blocks except for the Host 101 represent software or firmware functions programmed into a microcontroller such as microcontroller 44 in FIG. 4. The host 101 communicates with the microcontrollers via the fieldbus network trunk line 102.

From start block 90, the fieldbus microcontroller 44 periodically checks inputs at block 92, reading data so that it can otherwise operate the device specific hardware 46. It checks also to see if there is an interrupt at program step 94. If the answer is “no” the fieldbus microcontroller performs the next step of its normal fieldbus function at program step 96. It then loops back to start 90 at program step 98.

The fieldbus microcontroller may be programmed by the host 101, and an example appears at program step 100 where the host sets alarm limits and either enables or disables an alarm. If the answer at node 94 is “yes” there has been a PhLD interrupt and the fieldbus microcontroller reads the interrupt data from the PhLD measurement hardware 42 at program step 102. The data is compared with alarm limit thresholds that were set in program step 100. If the alarm limit threshold has been exceeded at the node 104, the fieldbus microcontroller next determines if the alarm is “on” at program step 106. If “yes” the alarm limit data and the alarm are transmitted back to the start 90 at program step 108. If “no” the program loops back to program step 100 which may include transmission of data back to the start 90. From the start block 90, data may be transmitted to the host 101. All PhID data is readable by the host, whether alarm limits are reached or not.

There are a number of other measurement functions that could be implemented in this way and the above examples are intended to be merely illustrative, not exhaustive. In addition, the microcontrollers such as microcontrollers 56, 66, 76, and 86 could exist separately from the microcontroller operating the functional layer of the fieldbus device. In such a case, the PhLD hardware would have its own microcontroller, which would then communicate with the fieldbus microcontroller. This may be required in the case of certain types of PhLD measurements such as jitter or oscilloscope measurements.

The terms and expressions that have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A fieldbus device within a fieldbus network segment, said fieldbus device comprising a functional layer and a physical layer diagnostic (PhLD) element included within said fieldbus device for measuring an electrical parameter of the fieldbus network segment.

2. The fieldbus device of claim 1 wherein said fieldbus device includes a microcontroller for controlling an operation of said functional layer and said PhLD is coupled as an input to said microcontroller.

3. The fieldbus device of claim 2 wherein said microcontroller includes an analog to digital converter having an input coupled to said PhLD element.

4. The fieldbus device of claim 2 wherein said microcontroller includes a digital filter having an input coupled to said PhLD element.

5. The fieldbus device of claim 1 wherein said fieldbus network segment includes a trunk line comprising a wire pair, the wire pair having a positive wire and a negative wire and operating according to a fieldbus standard, wherein the PhLD element is coupled to the positive wire of the wire pair.

6. A fieldbus segment containing a fieldbus device, the fieldbus device being coupled to a wire pair operating according to a fieldbus standard, the fieldbus device comprising
(a) A fieldbus device interface coupled to said wire pair;
(b) A PhLD element coupled to one wire of said wire pair for measuring a predetermined electrical parameter of said fieldbus segment,
(c) A fieldbus microcontroller coupled to said fieldbus device interface and having an input coupled to said PhLD circuit, and
(d) A functional layer coupled to an output of said fieldbus microcontroller for performing a predetermined function in an industrial process.

7. The fieldbus segment of claim 5 wherein said PhLD element is coupled to said fieldbus microcontroller through an analog to digital converter.

8. The fieldbus segment of claim 5 wherein said PhLD element is configured to measure DC voltage.

9. The fieldbus segment of claim 5 wherein said PhLD element is configured to measure DC current.

10. The fieldbus segment of claim 5 wherein said PhLD element is configured to measure noise.

11. The fieldbus segment of claim 5 wherein said PhLD element is configured to measure signal level.

12. The fieldbus segment of claim 5 wherein said PhLD element is configured to measure jitter.

13. The fieldbus segment of claim 5 wherein said PhLD element is configured to provide oscilloscope screen capture.

14. The fieldbus device of claim 2 wherein said microcontroller includes coded instructions for:
(a) Setting an alarm limit threshold value for a parameter of said fieldbus network segment;
(b) Comparing parameter data obtained from said PhLD element with said alarm limit threshold value; and,
(c) Transmitting a signal to a host when said parameter data exceeds said alarm limit threshold value.

15. The fieldbus device of claim 14 wherein said microcontroller includes coded instructions for enabling or disabling an alarm, said alarm being indicative of whether said parameter data exceeds said threshold value.

16. The fieldbus device of claim 15 having means for communicating PhLD data measured by said PhLD element to said host over a fieldbus network.

17. The fieldbus device of claim 16 wherein said threshold value is set by said host.

18. The fieldbus device of claim 17 wherein an alarm is enabled by said host.

19. A fieldbus network having at least one fieldbus segment, comprising:
(a) A host;
(b) A fieldbus segment located in a plant environment, said fieldbus segment being coupled to said host; and,
(c) Said fieldbus segment including at least one fieldbus device having an integral PhLD measurement element for measuring an electrical parameter of said fieldbus segment.

20. The fieldbus network of claim 19 wherein said PhLD element is coupled to a spur line in said segment so as to measure an electrical parameter thereof.

21. The fieldbus device of claim 20 wherein said fieldbus device includes a microcontroller and said PhLD is coupled to an analog to digital converter connected to said microcontroller.

22. The fieldbus network of claim 21 wherein said fieldbus device includes a fieldbus device interface and said PhLD element is connected to said microcontroller in parallel with said fieldbus device interface.
